(19) United States
(12) Patent Application Publication
(10) Pub. No.: US 2017/0303519 A1
(43) Pub. Date: Oct. 26, 2017

(54) FISHING LURES

(71) Applicant: BnR Tackle LLC, Hermiston, OR (US)

(72) Inventor: Brandon G. Wedam, North Plains, OR (US)

(21) Appl. No.: 15/643,913

(22) Filed: Jul. 7, 2017

Related U.S. Application Data
(63) Continuation-in-part of application No. 14/791,190, filed on Jul. 2, 2015, now abandoned.

(51) Int. Cl. A01K 85/00; A01K 91/04

(52) U.S. Cl. CPC A01K 85/00; A01K 91/04

(57) ABSTRACT

The disclosed fishing lure systems have a fishing lure, bead sleeve, and a stop that can be used in combination with a fishing line and hook. The fishing lure has a pliable body and a pre-formed hole. The bead sleeve can be fitted within the pre-formed hole with an interference fit because the pliable body expands to fit around the bead sleeve to hold it in place within the pre-formed hole. The stop is positioned on one side of the fishing lure and bead sleeve to prevent it from sliding down towards the hook or possibly over some portion of the hook. The stop can be positioned spaced apart from the hook on a fishing line so that the distance between the fishing lure and the hook remains at a desirable spacing while in use.

### CROSS-REFERENCE TO RELATED APPLICATIONS

This application is a Continuation-in-Part of U.S. Non-Provisional application Ser. No. 14/791,190, entitled, “Soft Fishing Bead,” filed Jul. 2, 2015, which is incorporated herein by reference in its entirety for all purposes.

### BACKGROUND

Most anglers are passionate about fish and the equipment they use to catch them. Some anglers even refer to fishing as a religion or an addiction and take great care preparing their equipment to maximize the experience and pleasure of catching fish. Anglers tend to use a variety of lures, including a combination of live bait and artificial lures. Artificial lures provide anglers with a wide variety of options to entice fish to bite. Steelhead and salmon anglers, for example, may use artificial lures that resemble common food sources for the fish they wish to catch. Many salmon, steelhead, and trout anglers are interested in a fishing technique called bead-fishing in which the artificial lure emulates a fish egg, which is a nutrient-rich food source. Conventional artificial lures specific to bead-fishing use hard, dense materials or solid soft materials that either sink in the water or are difficult to thread onto a fishing line, respectively, especially in unfavorable weather or lighting conditions that often happen on a fishing trip.

Anglers that use bead-fishing techniques usually want the artificial lure to be placed a particular distance away from the fishing hook to minimize the risk that a hooked fish will suffer a fatal injury when hooked and can safely be returned to their habitat after being caught. Conventional bead-fishing requires significant time and resources to thread beads onto the fishing line, either because they are rigid and require attention at each use or because they are a solid soft material and require that the angler pierce the solid bead with the hook and awkwardly thread the bead onto the line securing it in place with a bead stop that still often migrates along the line during use.

The art would benefit from a new fishing system with a lure that is easily and efficiently attached to a fishing line and hook and that can be reusable and help minimize injury to the hooked fish.

### SUMMARY

An example of the disclosed fishing lure systems include a fishing lure, a bead sleeve, and a stop. The fishing lure has a pliable body and a pre-formed hole having a hole diameter. The pre-formed hole extends through a central portion of the body and has a hole length with a first line end and a second, opposing hook end. The bead sleeve has a sleeve diameter and a sleeve length with a line end and an opposing hook end. The sleeve diameter is greater than the hole diameter and is sized to provide an interference fit between the fishing lure and the bead sleeve when the bead sleeve is inserted into the pre-formed hole. The stop has a stop diameter larger than the sleeve diameter and is positioned on the hook end of the bead sleeve.

Another example fishing lure system has a fishing lure, a bead sleeve, a stop, a fishing line, and a hook. The fishing lure has a pliable body and a pre-formed hole with a hole diameter. The bead sleeve has a sleeve diameter and a sleeve length. The sleeve diameter is greater than the hole diameter. The bead sleeve is fitted into the hole of the fishing lure to provide an interference fit between the fishing lure and the bead sleeve. The stop has a stop hole with a stop diameter that is larger than the sleeve diameter. The fishing line is positioned to extend through the bead sleeve and the stop hole. The hook has an attachment element that is structured to be secured to an end of the fishing line opposite from the fishing lure.

### BRIEF DESCRIPTION OF THE DRAWINGS

Non-limiting and non-exhaustive embodiments of the invention are described with reference to the following drawings. In the drawings, like reference numerals refer to like parts throughout the various figures, unless otherwise specified, wherein:

FIG. 1 shows a prior art hard bead and rigid stopper fishing system.

FIG. 2 shows an exploded view of an example fishing system, according to the disclosure.

FIG. 3 shows the example fishing system of FIG. 2 positioned on a fishing line with a hook.

FIG. 4 shows an example of removing the fishing lure of the example fishing lure system shown in FIG. 2.

FIG. 5 shows an example of placing a new fishing lure onto the lure system of FIG. 2.

FIG. 6 shows an alternative example fishing system in accordance with the disclosure.

FIG. 7 shows another example fishing system according to the disclosure.

### DETAILED DESCRIPTION

Many anglers enjoy using a bead-fishing technique to catch fish, especially when intending to catch-and-release the fish, to avoid damage to vital organs in the fish. Bead-fishing intends to maximize the likelihood that the hook will pierce the fish on the outside or near the outside of the fish's mouth. Beads can be any shape and often emulate natural food sources of the desired catch, which can be fish eggs in some species that are generally spherical. Most of the currently available fishing beads are made of a hard or rigid material and are dense which cause them to quickly sink in the water during use. Natural eggs are a pliable, biological material and do not instantly sink in the water. So while bead-fishing has grown in popularity, the conventional designs have many drawbacks.

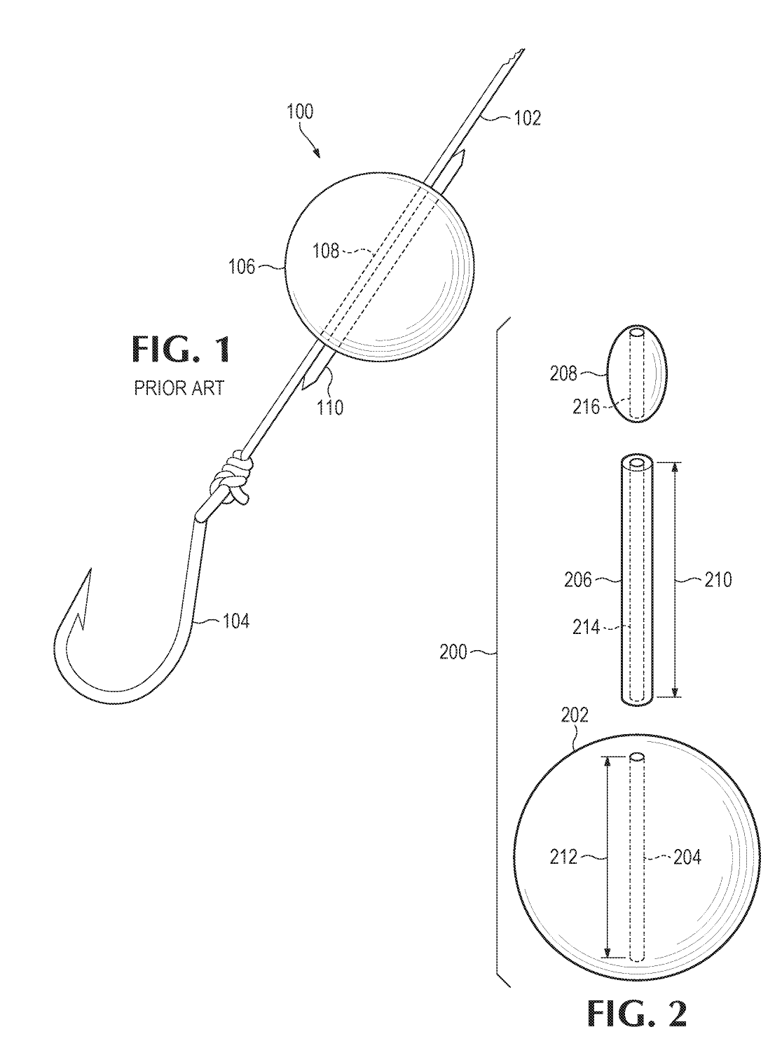

FIG. 1 shows an example prior art fishing bead system 100 fitted onto a fishing line 102 with a hook 104 attached to one end. The prior art fishing system 100 has a hard bead 106 with a spherical shape and is made of an inelastic, dense material like glass or ceramic. Anglers like to paint or otherwise decorate the exterior surface of the hard beads to more closely emulate food sources or to otherwise attract the fish so the conventional beads used for bead-fishing are hard to accommodate the paint and/or other decorations. The hard bead 106 shown in FIG. 1 has a pre-formed hole 108 through its center to allow the fishing line 102 to be threaded through it. The pre-formed hole 108 of the hard bead 106 freely slides along fishing line 102 because the pre-formed hole 108 has a greater diameter than the fishing line 102. Ideally, anglers like to position the hard bead 106 a certain distance away from the hook 104 so that it does not slide down towards the hook 104 and become lodged in the fish's mouth when a fish is hooked. Because the pre-formed hole 108 of the hard bead 106 is inelastic, anglers like to place a rigid stop 110 into the pre-formed hole 108 of the hard bead 106, like a stick, such as the broken-off toothpick shown in FIG. 1 to secure the hard bead 106 in place. Anglers also use semi-rigid or semi-flexible stops like a portion of a rubber band or other mechanism that can be fitted into the inelastic pre-formed hole 108 of the hard bead 106 and pressed against the fishing line 102. Unfortunately, the rigid or semi-rigid/flexible stop and hard bead combination still slides along the fishing line during use, especially when the angler is casting or if a fish is hooked and is thrashing its head in many directions.

Other, less conventionally used fishing beads can be made of a pliable material; however, they are completely solid with no hole and present different setbacks. Anglers using such solid soft beads are required to use a free-hand technique to pierce the soft bead with the hook and fit the hook through the soft bead to slide it on to the fishing line. Once fitted over the fishing line, these soft beads slide along the line and also require a stop to secure it in place. Similar to the hard beads, anglers using solid soft beads often insert a rigid, semi-rigid/flexible stop into the newly-created hole to attempt to secure the soft bead against the fishing line. However, the newly-created hole often has a rough interior surface and an irregular shape due to its piercing by the fishing hook. Similar to the hard bead design, the solid soft bead and stop combination also migrates along the fishing line during use, especially when casting and when a fish is hooked and thrashing its head.

The disclosed systems, methods, and lures have several advantages over the prior art hard bead or solid soft bead designs. FIG. 2 shows an example fishing lure system 200 with a pliable bead 202 having a pre-formed hole 204 through its length, a bead sleeve 206, and a stop 208. The bead 202 in this example is spherical, to emulate a fish egg, although it can be any suitable shape such as another fish food source like a worm, grub, lizard, frog, crayfish, fish, and the like. The size of the bead 202 can vary as well and may align with different phases of a fish egg diameter as it would normally naturally grow in size. For example, the bead size can be 6 millimeters (mm), 8 mm, 10 mm, 12 mm, 14 mm, 16 mm, or larger if desired. The diameter of the soft bead selected by the angler can be dependent on the water visibility in which the target fish resides or other environmental conditions. In some cases, multiple soft beads can be used together in a single fishing system and are fitted adjacent each on the same bead sleeve. The soft beads can be a variety of colors, textures, and patterns or other decorative feature(s).

FIG. 2 shows an exploded view of an example soft bead 202, bead sleeve 206, and stop 208. The bead sleeve 206 can be fitted into the flexible pre-formed hole 204 of the soft bead 202. The soft bead 202 is pliable and can be stretched or extended to fit around the more rigid bead sleeve 206. The elasticity of the soft bead 202 creates an interference fit between the bead sleeve and the interior surface of the pre-formed hole 204 of the soft bead 202 when the sleeve is inserted within it. The bead sleeve 206 has a diameter that is larger than the diameter of the pre-formed hole 204 of the soft bead 202 so that the soft bead has to be flexed and expanded to fit around the bead sleeve 206 for the sleeve 206 to be inserted within it. The bead sleeve 206 is also preferably made of a material that is more rigid that the material of the soft bead 202. In some examples, the bead sleeve is made of a semi-rigid material, such as acrylonitrile-butadiene-styrene (ABS). The soft bead 202 can be a pliable thermoplastic. In some examples, the pliable thermoplastic is selected with a shore durometer in a range of typical food sources, such as fish eggs. The shore durometer of the material for the bead sleeve can be more rigid or harder than the soft bead, such as a shore durometer in the range of 00 to 100. Other shore durometers can be used for both the soft bead and the bead sleeve, as needed. In some examples, the shore durometer is selected based on the environmental conditions, such as the type of fish being targeted and the cover or other objects likely to be present in the water, such as weeds, lily pads, wood or logs, other fish, rocks, and the like.

The bead sleeve 206 shown in FIG. 2 is a tube shape that mates with the interior shape of the cylindrical pre-formed hole 204 in the soft bead 202. Alternatively, the bead sleeve can have an exterior surface contour that is different than a mate to the interior of the pre-formed hole and could include ridges, textures, coatings, protrusions, or the like that interface with the interior surface of the pre-formed hole. Some example soft beads are created through a heated injection molding process and additives such as color, texture, scents, and other components can be added to the heated thermoplastic during the molding process. Methods of manufacturing the soft beads are discussed in more detail below.

The material selected for the soft beads can have a positive buoyancy, negative buoyancy or a neutral buoyancy characteristic when emerged in water. The average density of the soft bead can be adjusted to be approximately equal to, for neutral buoyancy; or less than, for positive buoyancy, the water based on the type of fishing for which the soft bead is intended. For example, the buoyancy characteristics of the soft bead material could be selected based on the type of fish food that the soft beads try to emulate so that they appear as close to live bait as possible. Still further, the soft bead material can be selected based on its elasticity to withstand the frictional forces applied to the soft bead, such as during trolling or when the fish is thrashing its head, and can also be selected based on its relation to the material selected for the bead sleeve.

The bead sleeve 206 shown in FIG. 2 has a sleeve length 210 that is greater than a length 212 of the pre-formed hole 204 in the soft bead. In the example shown in FIG. 2, the sleeve length 210 is slightly greater than the pre-formed hole length 212. The bead sleeve 206 can accommodate a single bead, the soft bead 202 shown in FIG. 2. Alternative examples have a bead sleeve 206 that is longer than the one shown in FIG. 2 and some of them can accommodate multiple soft beads on a single bead sleeve. One example system has a bead sleeve that is greater than the pre-formed hole length but is less than two times the pre-formed hole length. Other example systems have bead sleeves that exceed two times the pre-formed hole length. The bead sleeve length can be any desired length chosen by the angler.

In the example shown in FIG. 2, the bead sleeve 202 is a tube with a hollow interior 214. Other example bead sleeves can be different shapes and/or can have contours, textures, protrusions, or the like on their exterior surfaces. The interior, hollow surface 214 of the bead sleeve 206 can be smooth, such as the example shown in FIG. 2, or could alternatively be coated or otherwise shaped to help the fishing line interact with the bead sleeve as effectively as possible. For example, the interior, hollow surface of the bead sleeve can be coated with a lubricant to help reduce friction between the fishing line and the bead sleeve so the sleeve slides along the line or with a scent to attract the fish to the fishing lure system.

The fishing lure system 200 of FIG. 2 also includes a bead stop 208. The bead stop 208 has a pre-formed hole 216 formed through it. Bead stops can be any suitable shape although the stop 208 shown in FIG. 2 is an oval-shape. The diameter the stop 208 is greater than the diameter of the hollow interior 214 of the bead sleeve 206 which prevents the bead sleeve 214 from sliding past the stop 208 along the fishing line during use. The bead stop hole 216 has a diameter that is only slightly larger than the diameter of the fishing line to secure the bead stop on the fishing line by an interference fit or the bead stop hole 216 can have a diameter that is larger than the diameter of the fishing line and the angler ties a knot in the line between the stop 208 and the hook to prevent the stop from moving along the fishing line past the knot. In the disclosed systems, anglers place the bead stop 208 at the desired distance spaced apart from the fishing hook. Placement of the bead stop 208 then guides where the bead sleeve 206 can be positioned because the bead sleeve 206 cannot move past the stop 208 when the sleeve hollow, interior 214 is smaller than the diameter of the stop 208.

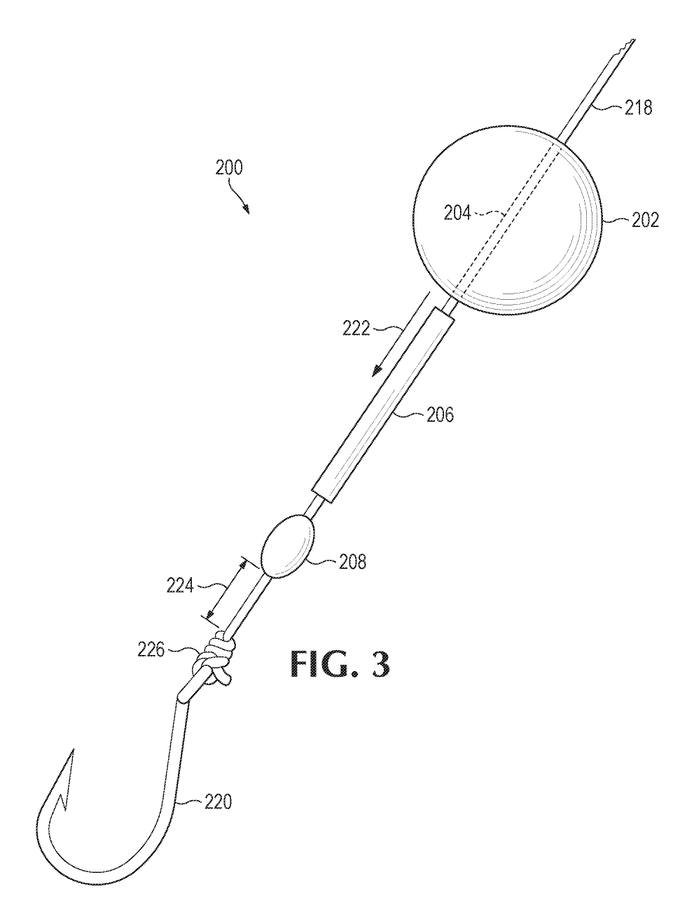

FIG. 3 shows the fishing lure system 200 of FIG. 2 on a fishing line 218 with an attached hook 220. The fishing line 218 is fed through the pre-formed hole 204 of the soft bead 202, the hollow, interior 214 of the bead sleeve 206, and the hole 216 of the stop 208. The arrow 222 indicates that the soft bead 202 is slid over the bead sleeve 206 so that the exterior surface of the bead sleeve 206 is in contact with and creates an interference fit with the interior surface of the pre-formed hole 204 of the soft bead 202. The bead stop 208 is positioned a distance 224 spaced apart from the hook 220 and is secured in place either by its own interference fit with the fishing line or by the knot 226 or other securing element that secures the hook 220 to the fishing line 218.

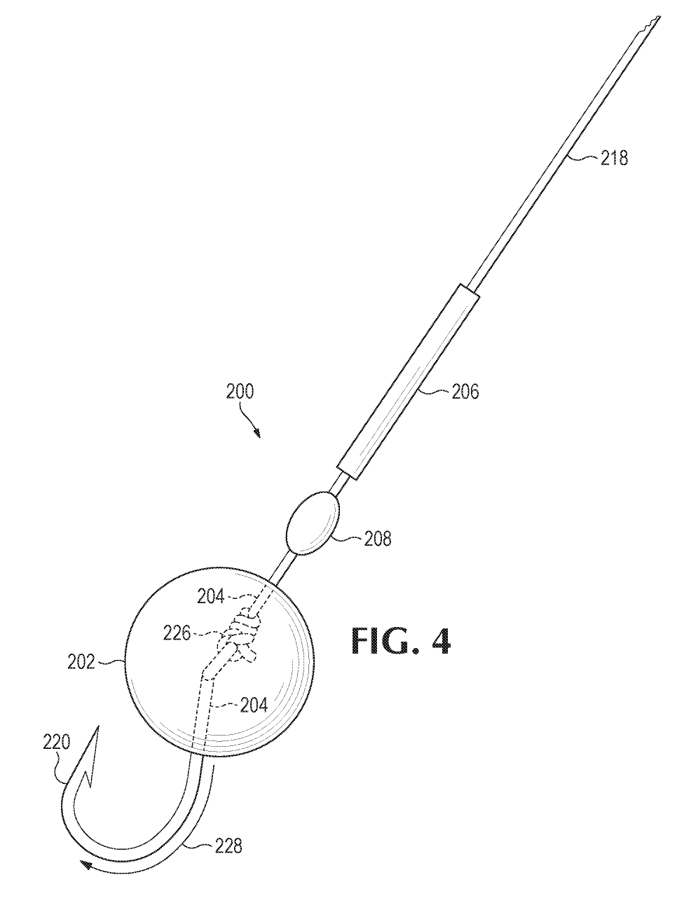

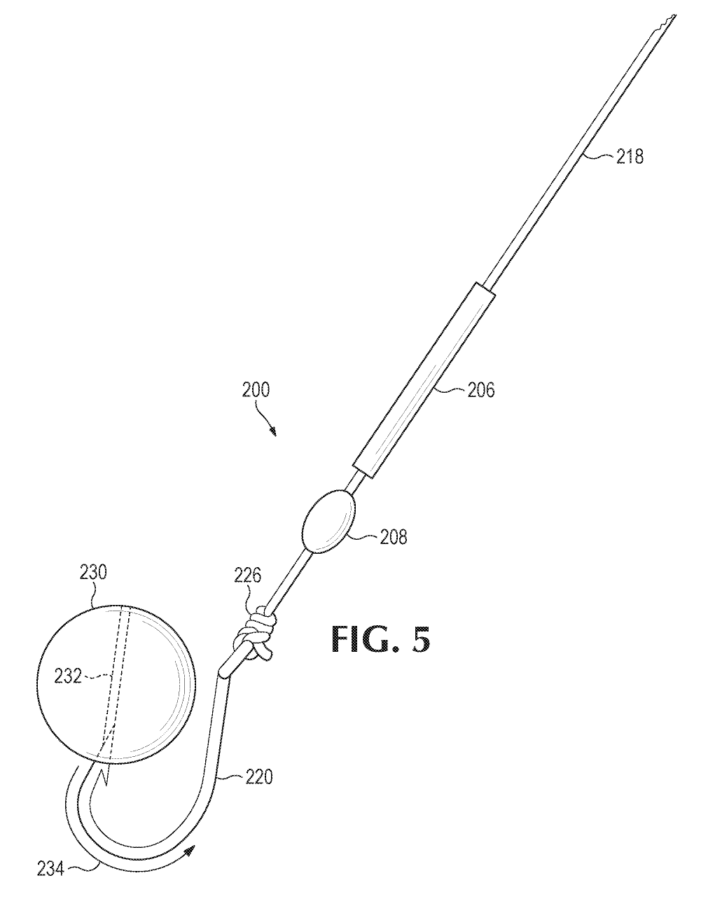

FIGS. 4 and 5 show the fishing lure system 200 from FIG. 2 as the soft bead 202 is removed from the fishing lure system 200. Because the soft bead is pliable, it can expand to be slid over the bead stop 208, the knot 226, and the hook to be removed from the system 200, as shown in FIG. 4 by arrow 228. As the soft bead 202 is being removed, the pliability of its material allows for the pre-formed hole 204 to flex and expand, as needed. FIG. 4 shows the pre-formed hole 204 in a flexed and expanded position to accommodate the knot 226 and a portion of the hook 220. FIG. 5 shows a new soft bead 230 being slid onto the fishing lure system 200. The new soft bead 230 is a different sized sphere than the original soft bead 202. In other examples, the new soft bead 230 can be the same sized sphere and can have a different shape, color, contour, texture, or any other different characteristic than the original soft bead 202. Similar to the original soft bead 202, new soft bead 230 and its pre-formed hole 232 are pliable. The pre-formed hole 232 flexes and expands to be slid over the hook and into the fishing lure system 200, as shown by arrow 234 in FIG. 5. The pre-formed hole 232 of the new soft bead 230 also flexes and expands to be slid over the stop 208 and the bead sleeve 206 in a similar fashion to the original soft bead 202.

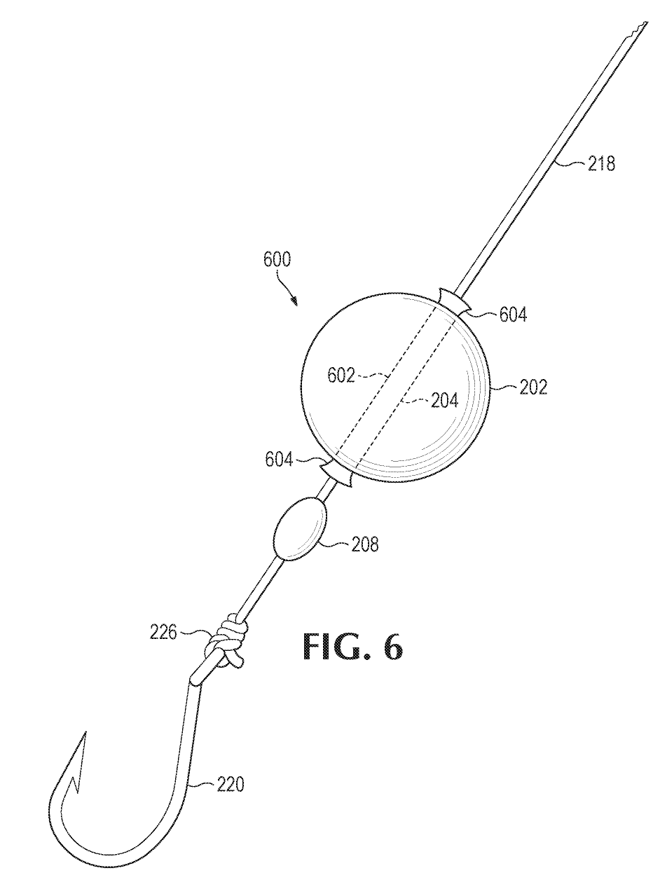

FIG. 6 shows another embodiment 600 of the disclosed fishing lure systems. The system 600 has the same elements as the embodiment shown in FIG. 2 including the soft bead 202 and a bead stop 204, but has a different bead sleeve 602. The bead sleeve 602 shown in FIG. 6 is a tube shape, like the sleeve 206 from FIG. 2, but also has radially extending protrusions on each end. The radially extending protrusions provide additional stops to prevent the soft bead 202 from sliding off of the bead sleeve 602 during use, such as when the fish is thrashing its head when it is hooked. Other embodiments have a bead sleeve with a radially extending protrusion on only one end of the bead sleeve or other types of protrusions on one or both ends of the bead sleeve.

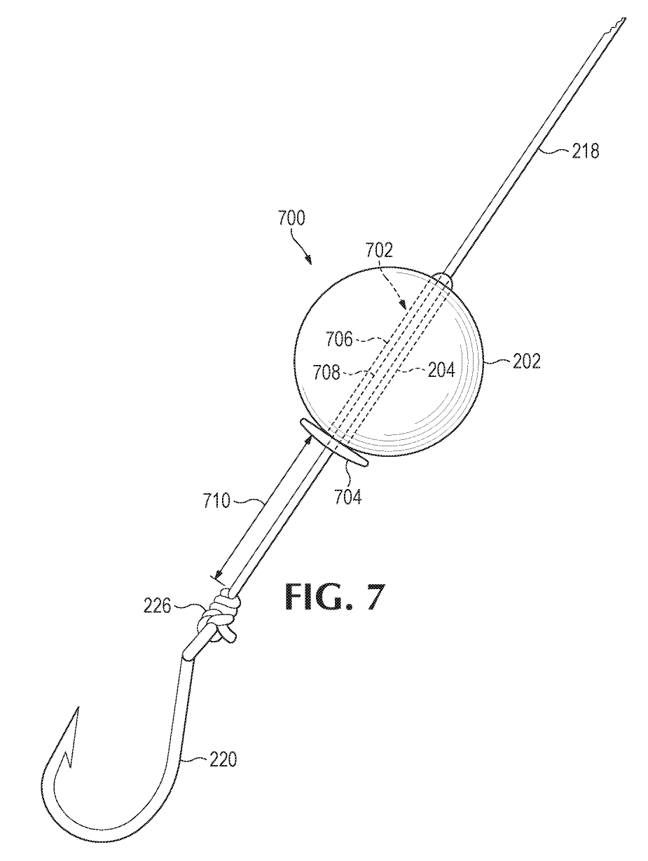

FIG. 7 shows another embodiment of a fishing lure system 700 with a soft bead 202. The bead sleeve 702 in this example has a saucer-shaped end 704 and a post 706 with a pre-formed hole 708 extending through it. The saucer-shaped end 704 is shaped to mate with the shape of an exterior surface of the soft bead 202 a distance 710 spaced apart from the fishing hook 220. The post 706 extends through the length of the pre-formed hole 204 of the soft bead 202 although it can be longer or shorter in other examples. The saucer-shaped end 704 of the bead sleeve 702 can form an interference fit with the fishing line 218 to secure the fishing lure system 700 in place on the fishing line 218 or anglers can optionally create a knot spaced apart from the fishing hook 220 and the knot 226 where the hook 220 attaches to the fishing line 218 to further secure the bead sleeve 702 in place.

The disclosed fishing lure systems can be packaged together in a kit having one or more soft beads, bead sleeves, and stops. For example, the kit could include multiple soft beads each of a different size, shape, contour, color, texture, etc. and a single bead sleeve. The kit can also include multiples of the same soft bead or could include one stop or multiple stops. Any suitable combination can be included in the kit.

The soft beads of the disclosed fishing lure systems in this application can be manufactured in several ways. For example, the soft beads can be made using an injection molding process that includes a mold having a soft bead body cavity and one or more wire cavities. To create a pre-formed hole through the soft bead, the injection molding process can use a lubricious surface, like an electropolished stainless steel wire such as a Kirschner wire used in medical applications, which is held in place using the wire cavities. The lubricious wire is suspended through the soft bead cavity. When the thermoplastic is poured into the soft bead cavit(ies) of the mold, the wire extends through the thermoplastic. Once the soft bead is finished curing in the mold, it is removed from the mold and the lubricious wire is removed from the hole, which produces a soft bead with a hole that is pre-formed for an angler's use.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be used for realizing the invention in diverse forms thereof.

What is claimed is:

1. A fishing lure system, comprising:
a fishing lure having a pliable body and a pre-formed hole having a hole diameter, the pre-formed hole extending through a central portion of the body and having a hole length with a first line end and a second, opposing hook end;
a bead sleeve having a sleeve diameter and a sleeve length with a line end and an opposing hook end, the sleeve diameter greater than the hole diameter and sized to provide an interference fit between the fishing lure and the bead sleeve when the bead sleeve is inserted into the pre-formed hole; and
a stop having a stop diameter larger than the sleeve diameter, the stop positioned on the hook end of the bead sleeve.

2. The fishing lure system of claim 1, wherein the pliable body is a spherical shape.

3. The fishing lure system of claim 1, wherein the pliable body is shaped as a grub, lizard, frog, crayfish, fish, or worm.

4. The fishing lure system of claim 1, wherein the pliable body includes a thermoplastic.

5. The fishing lure system of claim 4, wherein the thermoplastic has a shore durometer with a value selected within a range of durometers of a food source.

6. The fishing lure system of claim 4, wherein the thermoplastic has a shore durometer with a value between 00 and 100.

7. The fishing lure system of claim 1, wherein the pliable body includes a material having a neutral buoyancy, a positive buoyancy, or a negative buoyancy.

8. The fishing lure system of claim 1, wherein the bead sleeve includes a semi-rigid Acrylonitrile-Butadiene-Styrene (ABS) tube.

9. The fishing lure system of claim 1, wherein the bead sleeve has at least one end with a radially extending protrusion.

10. The fishing lure system of claim 1, wherein both ends of the bead sleeve have radially extending protrusions.

10. The fishing lure system of claim 1, wherein the pre-formed hole and the bead sleeve have a mating cylindrical shape.

11. The fishing lure system of claim 1, wherein the pre-formed hole and the bead sleeve have mating shapes selected from the group consisting of a circular, oval shape, triangular, square, rectangular, or polygonal shape.

12. The fishing lure system of claim 1, wherein the sleeve length is greater than the hole length.

13. The fishing lure system of claim 12, wherein the sleeve length is also less than two times the length of the hole length.

14. The fishing lure system of claim 1, wherein the sleeve length is more than two times the length of the hole length.

15. The fishing lure system of claim 1, wherein stop is an oval shape.

16. The fishing lure system of claim 1, wherein the stop is positioned spaced apart from the hook end of the bead sleeve.

17. The fishing lure system of claim 1, wherein the stop is positioned adjacent to the hook end of the bead sleeve.

18. A fishing lure system, comprising:
a fishing lure having a pliable body and a pre-formed hole having a hole diameter;
a bead sleeve having a sleeve diameter and a sleeve length, the sleeve diameter greater than the hole diameter, the bead sleeve fitted into the hole to provide an interference fit between the fishing lure and the bead sleeve;
a stop having a stop hole with a stop diameter larger than the sleeve diameter;
a fishing line positioned to extend through the bead sleeve and the stop hole; and
a hook having an attachment element structured to be secured to an end of the fishing line opposite the stop from the fishing lure.

19. The fishing lure system of claim 17, wherein the bead sleeve diameter is greater than a diameter of the fishing line and the bead sleeve freely slides along the fishing line.

20. The fishing lure system of claim 17, wherein the stop is spaced apart from the hook.
